(19) United States
(12) Patent Application Publication
(10) Pub. No.: US 2021/0081567 A1
(43) Pub. Date: Mar. 18, 2021

(54) MONITORING DATA SHARING AND PRIVACY POLICY COMPLIANCE

(71) Applicant: International Business Machines Corporation, Armonk, NY (US)

(72) Inventors: Yoonyoung PARK, Cambridge, MA (US); Issa Sylla, Boston, MA (US); Panagiotis Karampourniotis, Cambridge, MA (US); Olivia Choudhury, Cambridge, MA (US); Daniel M. Gruen, Newton, MA (US); Amarendra DAS, Cambridge, MA (US)

(21) Appl. No.: 16/571,303

(22) Filed: Sep. 16, 2019

(51) Int. Cl. G06F 21/62; G06F 16/951

(52) U.S. Cl. CPC G06F 21/6263; G06F 16/951

(57) ABSTRACT

A computer-implemented method can include obtaining first website data that corresponds to content displayed on a first website. The method can further include obtaining a set of privacy policy rules that corresponds to the first website. The method can further include determining a first data-sharing relationship between the first website and a second website. The method can further include comparing the set of privacy policy rules to the first data-sharing relationship. The method can further include identifying a discrepancy between the set of privacy policy rules and the first data-sharing relationship. The method can further include generating a notification in response to identifying the discrepancy.

### BACKGROUND

The present disclosure relates to data sharing, and more specifically, to data sharing across websites.

A service provider can be an entity (e.g. a private company, government agency, organization, etc.) that can provide a website through which a user can engage in web-based activities (e.g. performing searches, purchasing products, participating in social networking, banking, etc.). Websites can implement tools, such as cookies, to track the user's activities. In some instances, information about the user's activities can be shared across different websites. Some websites offer privacy policies that specify the type of data the website may collect and how the website can use the collected data.

### SUMMARY

According to embodiments of the present disclosure, a computer-implemented method can include obtaining first website data. The first website data can correspond to content displayed on a first website. The method can further include obtaining a set of privacy policy rules. The set of privacy policy rules can correspond to the first website. The method can further include determining a first data-sharing relationship between the first website and a second website. The method can further include comparing the set of privacy policy rules to the first data-sharing relationship. The method can further include identifying a discrepancy between the set of privacy policy rules and the first data-sharing relationship. The method can further include generating a notification in response to identifying the discrepancy.

A system and a computer program product corresponding to the above method are also included herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example computing environment that includes a set of user devices, a computing device, a privacy policy compliance system, and a network, in accordance with embodiments of the present disclosure.

FIG. 2 depicts a flowchart of an example method for generating a map of data-sharing relationships and determining website privacy policy violations, in accordance with embodiments of the present disclosure.

FIG. 3 depicts the representative major components of a computer system that can be used in accordance with embodiments of the present disclosure.

FIG. 4 depicts a cloud computing environment according to an embodiment of the present disclosure.

FIG. 5 depicts abstraction model layers according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to determining data sharing across websites more particular aspects relate to determining whether data sharing across websites violates a privacy policy. While the present disclosure is not necessarily limited to such applications, various aspects of the disclosure may be appreciated through a discussion of various examples using this context.

A website can utilize tools, such as cookies, to collect personal data (e.g., name, geographic location, email address, data about previous online searches and/or purchases, etc.) about a user who visits the website. Cookies can include first-party cookies that are created by the website the user is visiting and third-party cookies that are created by another entity (e.g., a website other than the website the user is visiting). In some cases, a website can request that a user consent to the website's use of cookies and/or other personal data collection tools before the user navigates the website. The website can also provide a privacy policy that specifies the type of data the website may collect and how the website can use the collected data.

Since personal data collected by a website can be shared across a plurality of websites and domains, both users and service providers may not know how such data is being shared and combined across the Internet. In some cases, companies can use personal data collected across multiple domains (e.g., across retail websites, medical services websites, and financial services websites) to generate a user profile that can determine web content for a user. Such a user profile can conflict with a user's interests and can violate a website's privacy policy.

To address these and other problems, embodiments of the present disclosure include a method and system that can generate a map of data-sharing relationships between websites and determine whether discrepancies may exist between a website's data-sharing activity and its privacy policy. In some embodiments, a map of data-sharing relationships can be a data visualization that represents a set of websites and a set of data-sharing relationships between the set of websites. Embodiments of the present disclosure can allow a user to identify whether a website is not in compliance with its privacy policy. Embodiments of the present disclosure can generate a map that allows a user to view how the user's personal data can be collected and shared across the Internet so that the user can make informed decisions about the user's web-based activities (e.g., whether to visit certain sites, whether to consent to a website's use of cookies and/or other personal data collection tools, whether to delete certain cookies, etc.). Thus, embodiments of the present disclosure can facilitate the user's ability to limit the distribution of the user's personal data. Embodiments of the present disclosure can notify a website when its data-sharing activity conflicts with its privacy policy so that the conflict can be resolved.

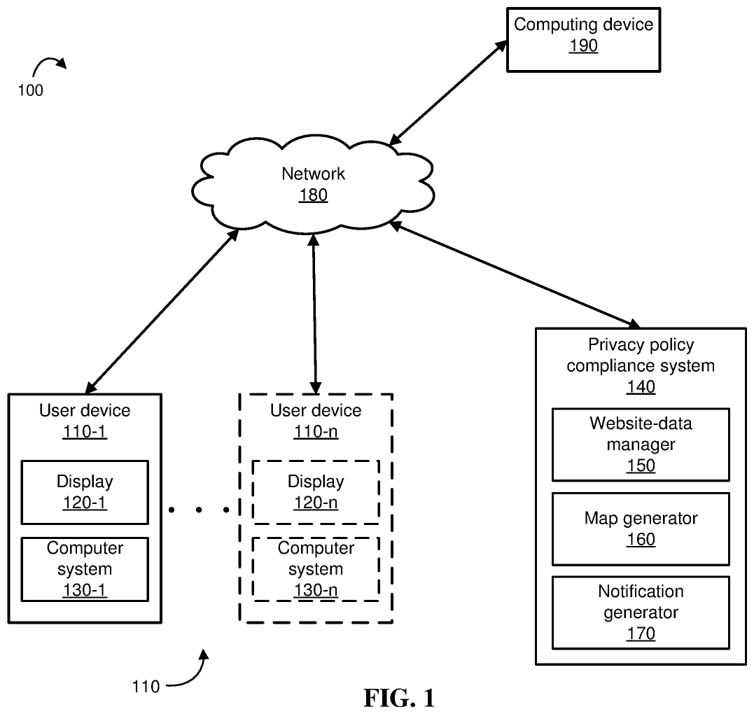

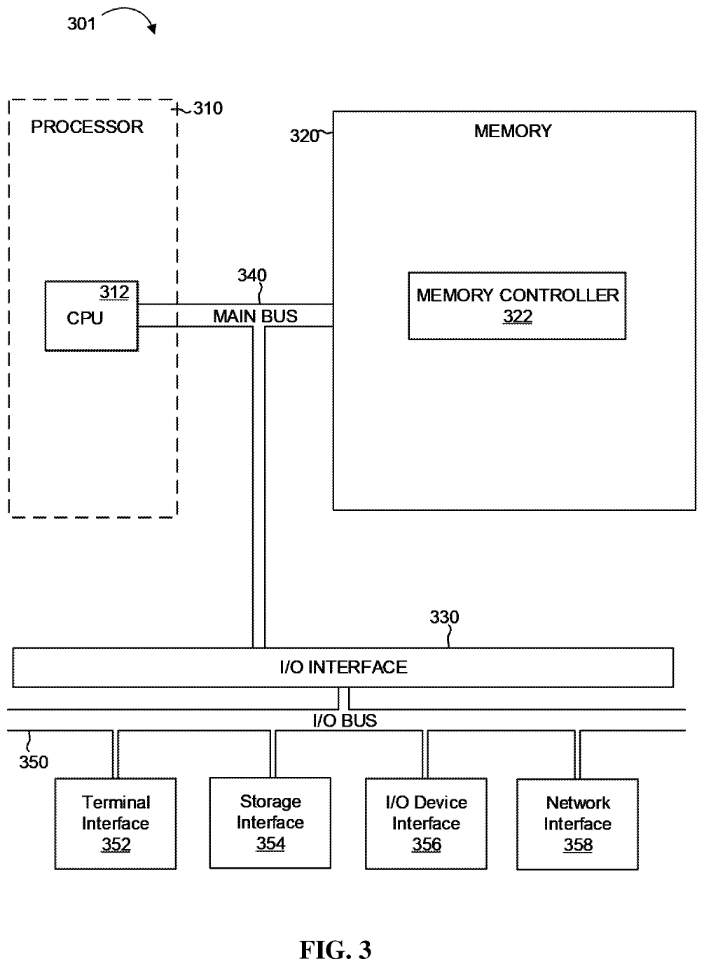

Turning to the figures, FIG. 1 illustrates an example computing environment 100 that includes a set of user devices 110, a computing device 190, a privacy policy compliance system 140, and a network 180, in accordance with embodiments of the present disclosure. The set of user devices 110 can include one or more user devices. For example, in some embodiments, the set of user devices 110 can include n devices, where n is an integer greater than zero. For example, n=1 in embodiments in which the set of user devices 110 includes only a first user device 110-1 having a first display 120-1 and a first computer system 130-1; n=2 in embodiments in which the set of user devices 110 includes two user devices (a first user device 110-1 having a first display 120-1 and a first computer system 130-1 and a second user device 110-2 having a second display 120-2 and a second computer system 130-2); and so on. In some embodiments, the set of user devices 110 can include at least one electronic device such as a computer, tablet, or mobile telephone. In some embodiments, one or more of the set of user devices 110, the computing device 190, and the privacy policy compliance system 140 can include a computer system, such as the computer system 301 shown in FIG. 3. In some embodiments, the computing environment 100 can include a plurality of computing devices 190, privacy policy compliance systems 140, and/or networks 180.

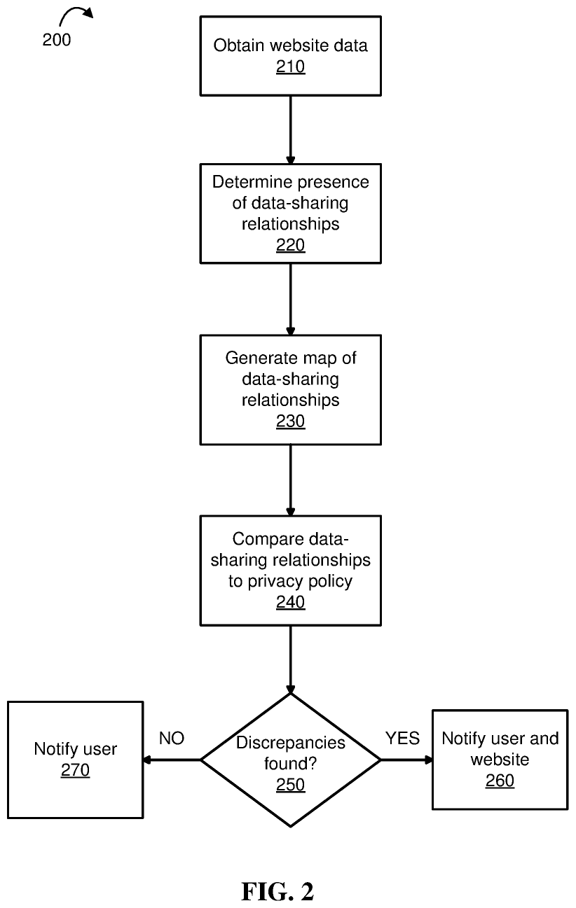

The first user device 110-1 includes a first display 120-1, such as an electronic visual display or a touch screen, and a first computer system 130-1. In some embodiments, the first display 120-1 can present websites, notifications, and/or maps of data-sharing relationships, to a user. In some embodiments, the first computer system 130-1 can include programming instructions to perform one or more method steps, such as those described in FIG. 2 below.

The set of user devices 110 can communicate with at least one of the computing device 190 and the privacy policy compliance system 140 via one or more networks 180. In some embodiments, the privacy policy compliance system 140 can be a computing device, such as a server, having a processor that implements one or more method steps, such as those described in FIG. 2 below. In some embodiments, the privacy policy compliance system 140 can include a computer system, such as the computer system 301 shown in FIG. 3, that can implement one or more method steps, such as those described in FIG. 2 below. In some embodiments, the privacy compliance system 140 can include a computer program or application, such as a browser plug-in application, implemented on a computer system, such as computer system 130-1.

In some embodiments, the privacy policy compliance system 140 can include a discrete website-data manager 150, map generator 160, and notification generator 170. In some embodiments, the website-data manager 150, map generator 160, and notification generator 170 can be integrated into a single device, such as a processor of the privacy policy compliance system 140. In some embodiments, one or more of the website-data manager 150, map generator 160, and notification generator 170 can be located remote from the privacy policy compliance system 140.

In some embodiments, the website-data manager 150 can be configured to obtain, store, and/or analyze web site data (e.g., cookie data, website content data, categories of website content, and/or privacy policy data). In some embodiments, the map generator 160 can be configured to determine data-sharing relationships between websites and generate one or more maps of data-sharing relationships between websites. In some embodiments, the notification generator 170 can be configured to determine discrepancies between a website's data-sharing activity and its privacy policy. In some embodiments, the notification generator 170 can provide notifications and/or privacy policy compliance determinations to one or more user devices and/or one or more websites.

In some embodiments, the computing device 190 can be an electronic device such as a server or a computer. In some embodiments, the computing device 190 can be configured to store website data, one or more maps of data-sharing relationships, and/or one or more privacy policy compliance determinations. In some embodiments, data stored on the computing device 190 can be obtained by at least one of the set of user devices 110 and the privacy policy compliance system 140.

FIG. 2 illustrates a flowchart of an example method 200 for generating a map of data-sharing relationships and determining website privacy policy violations, in accordance with embodiments of the present disclosure. The method 200 can be performed by a privacy policy compliance system, such as the privacy policy compliance system 140 described with respect to FIG. 1. Referring back to FIG. 2, in step 210, the privacy policy compliance system can obtain website data. Website data can include information about cookies, such as a cookie type or source, Uniform Resource Locator (URL) information, and/or content information, such as advertisements, text, images, and underlying Hypertext Markup Language (HTML) codes that can be displayed on a website. In some embodiments, website data can include text and/or images input into a website by a user.

In some embodiments, step 210 can include the privacy policy compliance system determining a category for website data. For example, in some embodiments, the privacy policy compliance system can be configured to identify, based on a URL or HTML coding, whether content, such as an advertisement, pertains to a particular good or a particular service. For example, in some embodiments, the privacy policy compliance system can determine whether an advertisement pertains to a financial service category (e.g., banking, investing, etc.) or a medical service category (e.g., dentistry, chiropractic, etc.). In some embodiments, the privacy policy compliance system can utilize image analysis and/or natural language processing technology to categorize website data (e.g., to determine that text and/or images on a webpage pertain to a category such as automobiles or real estate).

In some embodiments, step 210 can include the privacy policy compliance system obtaining, storing, and/or analyzing a website's privacy policy. For example, in some embodiments, the privacy policy compliance system can obtain a text copy of a website's privacy policy and implement natural language processing technology to identify a set of rules included in the policy. For example, the privacy policy compliance system can identify rules such as a rule that the website does not use third-party cookies and/or a rule that the website does not share data with third-party companies.

In some embodiments, step 210 can include the privacy policy compliance system obtaining a website's rating for the website's data tracking practices. For example, such a rating may be obtained from a third-party service that monitors the website's reputation for handling user data.

In some embodiments, step 210 can include the privacy policy compliance system obtaining and storing website data based on an individual user's web-based activities. For example, in some embodiments, the privacy policy compliance system can be included on a single user device, such as the user device 110-1 discussed with respect to FIG. 1. In these embodiments, the privacy policy compliance system can obtain website data corresponding to web-based activities performed on that user device. In some embodiments, the privacy policy compliance system can obtain and store website data based on a plurality of users' web-based activities. For example, in some embodiments, the privacy policy compliance system can be included on a remote server that can obtain website data from a plurality of user devices. In some embodiments, the privacy policy compliance system can utilize a set of web robots (bots) independently or in conjunction with one or more users to obtain website data. For example, in some embodiments, a set of bots can be programmed to visit websites and input data and/or make selections on those websites while the privacy policy compliance system obtains website data corresponding to such web-based activities. In these embodiments, the use of bots can significantly increase the quantity of obtained website data and can improve the accuracy of the map generation discussed below.

In step 220, the privacy policy compliance system can determine the presence of data-sharing relationships between websites. A data-sharing relationship can be an indication that personal data is shared between websites. In some embodiments, such an indication can be based on an explicit connection and/or an implicit connection between websites, as discussed in further detail below. In some embodiments, a website can have a data-sharing relationship with one or more other websites. Step 220 can include the privacy policy compliance system comparing and/or analyzing website data acquired in step 210. In some embodiments, step 220 can include comparing website data from a set of websites visited by one or more users and/or bots over time.

For example, in some embodiments, the privacy policy compliance system can compare website data acquired from a set of 30 websites visited by a user over a two-hour time period. In this example, the privacy policy compliance system can determine whether data-sharing relationships exist between websites of the set of 30 websites. In another example, in some embodiments, the privacy policy compliance system can compare website data acquired from a set of 10,000 websites visited by a group of 50 users and 20 bots over a two-day time period. In this example, the privacy policy compliance system can analyze trends (e.g., whether websites of the set of websites appear to have data-sharing relationships that are consistent over time and/or are consistent between the users and/or bots of the group).

In some embodiments, the privacy policy compliance system can determine a data-sharing relationship based on an explicit connection between websites. An explicit connection between websites can include a readily observable communication path between websites. For example, a first website can have an explicit connection with a second website when the first website and the second website include the same cookie or the same cookie source (e.g., a first website and a second website each include a cookie from the same advertising company). In another example, the privacy policy compliance system can determine that an explicit connection exists between a first website and a second website when either website includes a direct hyperlink to the other website.

In some embodiments, the privacy policy compliance system can determine a data-sharing relationship based on an implicit connection between websites. An implicit connection between websites can include a communication path that is not readily observable. For example, in some embodiments, the privacy policy compliance system can determine an implicit connection when a first website and a second, subsequently visited website include the same content (e.g., both websites include the same advertisement, particularly in the case where a user sees the advertisement on the second website after seeing the advertisement on the first website). In some embodiments, the privacy policy compliance system can determine an implicit connection when content relevant to a user activity on a first website appears on a second, subsequently visited website. For example, in some embodiments, a user can search for an item, such as a pair of running shoes, on a first website, and a second website that is subsequently visited by the user can include an advertisement for shoes. In some instances, the subsequent advertisement can refer to the same running shoes the user searched for, and in some instances, the subsequent advertisement can generally correspond to the category: shoes (e.g., the subsequent advertisement can refer to a sale at a shoe store or a new model of hiking shoes). In either instance, the privacy policy compliance system can determine an implicit connection.

In some embodiments, in step 220, the privacy policy compliance system can generate a confidence value that corresponds to an implicit connection between websites. The confidence value can represent a degree of certainty that a data-sharing relationship exists between websites. In some embodiments, the confidence value can be based, at least in part, on data aggregated over time from one or more users and/or bots. For example, in some embodiments, the privacy policy compliance system can monitor visits to a first website and a second website by multiple users. Further in this example, the privacy policy compliance system can determine, for 75% of the monitored visits, a presence of an implicit connection between the first website and the second website. Accordingly, in this example, the privacy policy compliance system can generate a confidence value of 75% certainty that a data-sharing relationship exists between the first website and the second website. In some embodiments, a confidence value generated by the privacy policy compliance system can be directly proportional to a number of monitored visits in which the privacy policy compliance system determines the presence of an implicit connection. Thus, in the example above, the privacy policy compliance system can generate a higher confidence value when it determines that a greater number of monitored visits show implicit connections, and in some instances, it can generate a lower confidence value when it determines that a lower number of monitored visits show implicit connections.

In step 230, the privacy policy compliance system can generate a map of data-sharing relationships between websites. Such a map can be a data representation (e.g., a database or data visualization) of a set of websites and the data-sharing relationships between them. For example, in some embodiments, such a map can include data visualization having a set of nodes that represent two or more websites and a set of edges that represent data-sharing relationships between the two or more websites. In some embodiments, the set of edges can include a corresponding confidence value generated by the privacy policy compliance system. In some embodiments, the privacy policy compliance system can include website data obtained in step 210, such as website ratings, or node attributes. In some embodiments, in step 230, the privacy policy compliance system can provide a user notification that identifies one or more websites that are likely to share personal data. Such identification can be based on a website rating (e.g., a rating corresponding to website's reputation for handling user data) and/or data aggregated over time from one or more users and/or bots. Additionally, the privacy policy compliance system can include the notification in the map of data-sharing relationships and/or independently (e.g., within a browser on a display of a user device).

In some embodiments, step 230 can include the privacy policy compliance system generating a personal map for an individual user based on the user's web-based activities. In some embodiments, step 230 can include the privacy policy compliance system generating a global map for a plurality of users based on web based activities of a plurality of users and/or a plurality of bots. Embodiments that include a global map can provide improved accuracy based on the quantity of data utilized to generate the global map.

In some embodiments, method 200 can end with step 230; however, in some embodiments, in step 240, the privacy policy compliance system can compare the determined data-sharing relationships to the privacy policy rules identified in step 210. For example, in some embodiments, an identified privacy policy rule may have included that a first website did not share personal data with third parties. However, in some embodiments, the privacy policy compliance system may have determined a data-sharing relationship that allowed a third-party website to obtain personal data from the first website.

In step 250, if the privacy policy compliance system detects a discrepancy between a data-sharing relationship and a privacy policy rule, then in step 260, the privacy policy compliance system can notify one or more users and/or one or more websites. In the case that the privacy policy compliance system does not detect such a discrepancy in step 250, then in step 270, the privacy policy compliance system can notify the user (e.g., the privacy policy compliance system can provide the user a notification that no indication of a privacy policy violation was found). In some embodiments, a discrepancy can include an inconsistency between a data-sharing relationship and a privacy policy rule. For example, in some embodiments, the privacy policy compliance system can detect an indirect discrepancy when a first website's privacy policy states that it does not ever share user data, but the privacy policy compliance system discovers advertisements on a second website that correspond to text searches the user performed on the first website. Such a discovery can indicate that the first website may be operating in violation of its privacy policy. In another example, in some embodiments, the privacy policy compliance system can detect a direct discrepancy when a website's privacy policy states that the website does not use third-party cookies, but the privacy policy compliance system identifies a third-party cookie on the website.

FIG. 3 depicts the representative major components of an exemplary Computer System 301 that can be used in accordance with embodiments of the present disclosure. The particular components depicted are presented for the purpose of example only and are not necessarily the only such variations. The Computer System 301 can comprise a Processor 310, Memory 320, an Input/Output Interface (also referred to herein as I/O or I/O Interface) 330, and a Main Bus 340. The Main Bus 340 can provide communication pathways for the other components of the Computer System 301. In some embodiments, the Main Bus 340 can connect to other components such as a specialized digital signal processor (not depicted).

The Processor 310 of the Computer System 301 can be comprised of one or more CPUs 312. The Processor 310 can additionally be comprised of one or more memory buffers or caches (not depicted) that provide temporary storage of instructions and data for the CPU 312. The CPU 312 can perform instructions on input provided from the caches or from the Memory 320 and output the result to caches or the Memory 320. The CPU 312 can be comprised of one or more circuits configured to perform one or more methods consistent with embodiments of the present disclosure. In some embodiments, the Computer System 301 can contain multiple Processors 310 typical of a relatively large system. In other embodiments, however, the Computer System 301 can be a single processor with a singular CPU 312.

The Memory 320 of the Computer System 301 can be comprised of a Memory Controller 322 and one or more memory modules for temporarily or permanently storing data (not depicted). In some embodiments, the Memory 320 can comprise a random-access semiconductor memory, storage device, or storage medium (either volatile or non-volatile) for storing data and programs. The Memory Controller 322 can communicate with the Processor 310, facilitating storage and retrieval of information in the memory modules. The Memory Controller 322 can communicate with the I/O Interface 330, facilitating storage and retrieval of input or output in the memory modules. In some embodiments, the memory modules can be dual in-line memory modules.

The I/O Interface 330 can comprise an I/O Bus 350, a Terminal Interface 352, a Storage Interface 354, an I/O Device Interface 356, and a Network Interface 358. The I/O Interface 330 can connect the Main Bus 340 to the I/O Bus 350. The I/O Interface 330 can direct instructions and data from the Processor 310 and Memory 320 to the various interfaces of the I/O Bus 350. The I/O Interface 330 can also direct instructions and data from the various interfaces of the I/O Bus 350 to the Processor 310 and Memory 320. The various interfaces can comprise the Terminal Interface 352, the Storage Interface 354, the I/O Device Interface 356, and the Network Interface 358. In some embodiments, the various interfaces can comprise a subset of the aforementioned interfaces (e.g., an embedded computer system in an industrial application may not include the Terminal Interface 352 and the Storage Interface 354).

Logic modules throughout the Computer System 301—including but not limited to the Memory 320, the Processor 310, and the I/O Interface 330—can communicate failures and changes to one or more components to a hypervisor or operating system (not depicted). The hypervisor or the operating system can allocate the various resources available in the Computer System 301 and track the location of data in Memory 320 and of processes assigned to various CPUs 312. In embodiments that combine or rearrange elements, aspects of the logic modules' capabilities can be combined or redistributed. These variations would be apparent to one skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

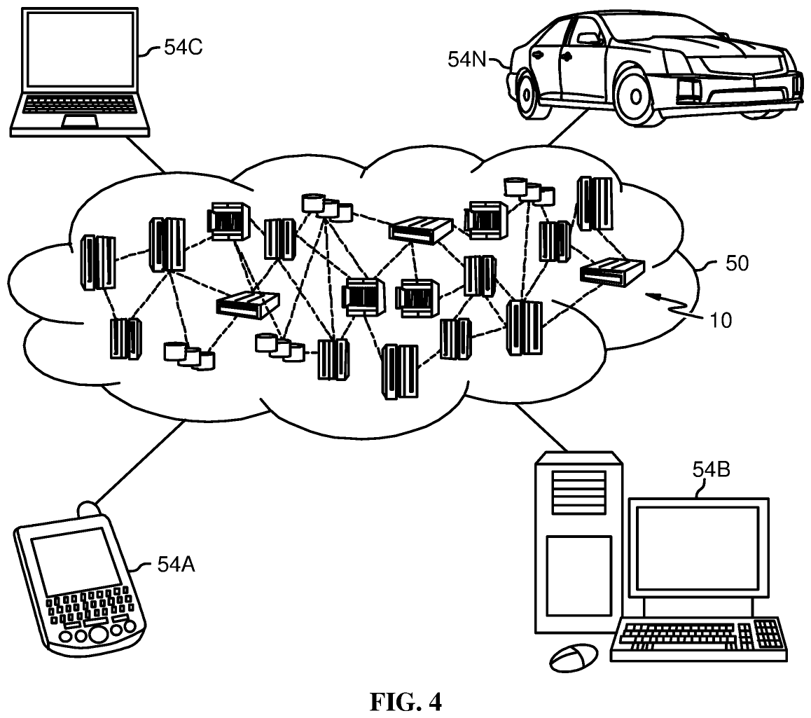

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

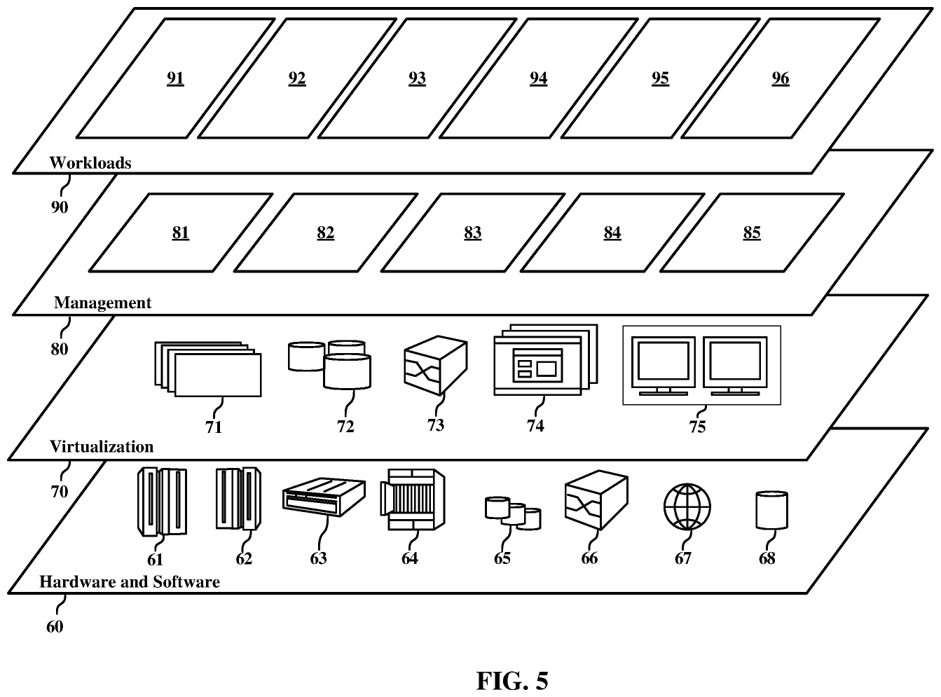

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and privacy policy compliance logic 96.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining first website data that corresponds to content displayed on a first website;
obtaining a set of privacy policy rules that corresponds to the first website;
determining a first data-sharing relationship between the first website and a second website;
comparing the set of privacy policy rules to the first data-sharing relationship;
identifying a discrepancy between the set of privacy policy rules and the first data-sharing relationship; and
generating a notification in response to identifying the discrepancy.

2. The computer-implemented method of claim 1, further comprising:
determining a second data-sharing relationship between the first website and a third website; and
generating a map representative of both the first data-sharing relationship and the second data-sharing relationship.

3. The computer-implemented method of claim 1, wherein obtaining the first website data comprises obtaining the first website data from a plurality of user devices.

4. The computer-implemented method of claim 3, wherein obtaining the first website data further comprises obtaining the first website data from a plurality of web robots.

5. The computer-implemented method of claim 1, wherein the first data-sharing relationship is based on an implicit connection between the first website and the second website.

6. The computer-implemented method of claim 1, wherein obtaining the first website data comprises determining a category for the first website data.

7. The computer-implemented method of claim 1, wherein the first data-sharing relationship is based on an explicit connection between the first website and the second website.

8. A system comprising:
a processor; and
a memory in communication with the processor, the memory containing program instructions that, when executed by the processor, are configured to cause the processor to perform a method, the method comprising:
obtaining first website data that corresponds to content displayed on a first website;
obtaining a set of privacy policy rules that corresponds to the first website;
determining a first data-sharing relationship between the first website and a second website;
comparing the set of privacy policy rules to the first data-sharing relationship;
identifying a discrepancy between the set of privacy policy rules and the first data-sharing relationship; and
generating a notification in response to identifying the discrepancy.

9. The system of claim 8, further comprising:
determining a second data-sharing relationship between the first website and a third website; and
generating a map representative of both the first data-sharing relationship and the second data-sharing relationship.

10. The system of claim 8, wherein obtaining the first website data comprises obtaining the first website data from a plurality of user devices.

11. The system of claim 10, wherein obtaining the first website data further comprises obtaining the first website data from a plurality of web robots.

12. The system of claim 8, wherein the first data-sharing relationship is based on an implicit connection between the first website and the second website.

13. The system of claim 8, wherein obtaining the first website data comprises determining a category for the first website data.

14. The system of claim 8, wherein the first data-sharing relationship is based on an explicit connection between the first website and the second website.

15. A computer program product comprising a computer readable storage medium having program instructions embodied therewith, wherein the computer readable storage medium is not a transitory signal per se, the program instructions executable by a processor to cause the processor to perform a method, the method comprising:
obtaining first website data that corresponds to content displayed on a first website;
obtaining a set of privacy policy rules that corresponds to the first website;
determining a first data-sharing relationship between the first website and a second website;
comparing the set of privacy policy rules to the first data-sharing relationship;
identifying a discrepancy between the set of privacy policy rules and the first data-sharing relationship; and
generating a notification in response to identifying the discrepancy.

16. The computer program product of claim 15, further comprising:
determining a second data-sharing relationship between the first website and a third website; and
generating a map representative of both the first data-sharing relationship and the second data-sharing relationship.

17. The computer program product of claim 15, wherein obtaining the first website data comprises obtaining the first website data from a plurality of user devices.

18. The computer program product of claim 17, wherein obtaining the first website data further comprises obtaining the first website data from a plurality of web robots.

19. The computer program product of claim 15, wherein the first data-sharing relationship is based on an implicit connection between the first website and the second website.

20. The computer program product of claim 15, wherein obtaining the first website data comprises determining a category for the first web site data.
